(19) United States
(12) Patent Application Publication
(10) Pub. No.: US 2023/0268793 A1
(43) Pub. Date: Aug. 24, 2023

(54) MOTOR FOR IMPACT TOOL

(71) Applicant: TECHTRONIC CORDLESS GP, Anderson, SC (US)

(72) Inventors: Wei Tong, Greenville, SC (US); Jarrett Dunston, Greenville, SC (US)

(21) Appl. No.: 18/169,680

(22) Filed: Feb. 15, 2023

Related U.S. Application Data
(60) Provisional application No. 63/312,759, filed on Feb. 22, 2022.

(51) Int. Cl. H02K 5/15; H02K 5/173; H02K 7/08; H02K 7/14; H02K 9/06; H02K 21/22

(52) U.S. Cl. CPC H02K 5/15; H02K 5/1732; H02K 7/083; H02K 7/145; H02K 9/06; H02K 21/22

(57) ABSTRACT

A motor includes a stator hub, an end cap, a shaft, a rotor, and a stator assembly. The stator hub includes a front plate portion positioned at a first end of the motor. The end cap is positioned at a second end of the motor. The shaft extends from the end cap through the front plate portion. The shaft is supported by at most two bearings spaced apart from each other along the axis. The rotor is coupled to the shaft and is configured to rotate the shaft. The stator assembly is disposed between the rotor and the shaft. Each of the rotor and the stator assembly is positioned between the front plate portion and the end cap along the axis.

### CROSS-REFERENCE TO RELATED APPLICATION

This application claims priority to U.S. Provisional Patent 63/312,759 filed on Feb. 22, 2022, the entire content of which is incorporated herein by reference.

### BACKGROUND

The present invention relates to power tools, and more particularly to impact tools and shaft support in impact tools.

Impact tools are typically utilized to provide a striking rotational force, or intermittent applications of torque, to a workpiece (e.g., a fastener) to either tighten or loosen the fastener. Impact tools typically provide a higher torque output than standard rotary tools. As such, impact tools may be desirable for fasteners requiring high torque tightening or loosening.

Ideally, a rotating electric machine, such as a motor, has just two bearings that act as point supports at the ends of a shaft. Thus, two bearings can be easily aligned along the motor shaft. However, some existing power tools have a motor and a long transmission shaft extending through the motor with a special topological structure. Typically, this setup requires three or more bearings to support the transmission shaft, especially under large external load conditions. However, the use of three or more bearings can cause some problems. The biggest disadvantage with putting a third bearing on the shaft is the need for precise alignment between all three bearings. Otherwise, for an inadequately aligned three-bearing system, bending moments and loads can be generated that adversely act on the shaft. This situation, called over-constraint, causes bearings to fail prematurely due to overloading of the shaft.

In such three-bearing systems, the power tool may be provided with a “bearing boot” for supporting at least one of the three bearings, where the bearing boot is made from elastomeric materials, such as rubber, with a high viscoelastic property and thus is highly deformable. The bearing boot is operable to isolate vibration or absorb shock caused by over-constraint of the motor during operation of the power tool. Thus, the bearing boot is provided to attempt to mitigate over-constraint issues. However, the bearing boot also increases the size, cost, and structural complexity of the motor which may be undesirable in some applications.

FIGS. 1-4 illustrate a typical three-bearing system of a motor. FIG. 1 shows a motor 110 that includes a stator hub 114, an end cap 118, a printed circuit board assembly 122, a rotor 126 with fan blades located at the rear end of the rotor 126, and a stator assembly 130. FIG. 2 shows that the motor 110 further includes a shaft 134 supported by a front bearing 138, a middle bearing 142, and a rear bearing 146. The front bearing 138 is positioned at the front of the stator hub 114. The middle bearing 142 is supported by the stator hub 114 within the stator assembly 130. The rear bearing 146 is positioned adjacent the end cap 118. The stator assembly 130 is located between the rotor 126 and the shaft 134. With reference to FIGS. 3 and 4, the end cap 118 receives a bearing boot 150 at the center of the end cap 118, and the rear bearing 146 is positioned within the bearing boot 150. The bearing boot 150 is made of an elastomeric material to provide a soft support for the shaft 134. Generally, elastomeric materials, such as rubber, are characterized by a rate-dependent viscoelasticity and can undergo large strains and nonlinear elastic deformation. As such, the bearing boot 150 has a low stiffness, and thus provides a soft support for the shaft 134 of FIG. 2. In practice, the three bearings 138, 142, 146 result in over constraint of the shaft 134.

According to the rotor configuration, an electric motor can be characterized as an internal-rotor motor or external-rotor motor. As the name implies, conventional brushless motors are constructed with a permanent magnet rotor located inside a wound stator where the rotor transmits torque through the output shaft. On the contrary, some motors are designed with the rotor on the outside and the stator housed inside the rotor. For this type of motor, permanent magnets are mounted on the inner diameter of the rotor and the rotor rotates around the internal stator. Thus, this type of motor eliminates the need for an output shaft reducing the overall motor footprint.

In addition to these two types of motor, there is a different type of motor that is used in certain applications, such as power tools (e.g., impact tools). Referring to FIG. 2, a different motor topology, a so-called “sandwich” topology, is applied to the motor 110. In this topology, the stator assembly 130 is inserted between the two rotating components: the shaft 134 and the rotor 126, where the shaft 134 and the rotor 126 are connected near a rear end of the shaft 134 and thus rotate at the same rotating speed and direction relative to the stator assembly 130. In this topology, two airgaps are present. One air gap is positioned between the shaft 134 and the stator assembly 130, and the other airgap is positioned between the rotor 126 and the stator assembly 130. As illustrated in FIG. 2, the illustrated sandwich topology has three bearings.

With reference to FIGS. 2 and 3, if the middle bearing 142 is removed from the motor 110, the soft support provided by the bearing boot 150 may cause an undesirable, atypical precession motion of the shaft 134. In other words, the rigid support of the front bearing 138 allows the shaft 134 to rotate but restricts eccentric movement of the shaft 134, whereas the soft support allows the shaft 134 to rotate and does not restrict eccentric movement of the shaft 134. As such, the soft support and rigid support combination may cause the shaft 134 to wobble with respect to an ideal axis of rotation. Further, precession angular velocity is inversely proportional to the spin angular velocity, such that the wobble is greater, or more pronounced, as the shaft 134 slows down. Therefore, the soft support and rigid support combination, as common in the art, are not desirable in a variety of applications.

In practice, to design a successfully working three-bearing system and reduce the risk of over-constraint, a restriction may be set on the shaft diameter to limit the shaft lateral rigidity. In addition, the span between the adjacent bearings cannot be very short, resulting in a longer motor overall length. Therefore, the ratio of the motor length to the shaft diameter (L/D) in a three-bearing system is larger than that in a two-bearing system, i.e., L_{3b}/D_{3b}>L_{2b}/D_{2b}.

### SUMMARY

In one aspect, the disclosure provides a motor for a power tool. The motor includes a stator hub, an end cap, a shaft, a rotor, and a stator assembly. The stator hub includes a front plate portion positioned at a first end of the motor. The end cap is positioned at a second end of the motor. The shaft extends from the end cap through the front plate portion. The shaft is supported by at most two bearings spaced apart from each other along the axis. The rotor is coupled to the shaft and is configured to rotate the shaft. The stator assembly is disposed between the rotor and the shaft. Each of the rotor and the stator assembly is positioned between the front plate portion and the end cap along the axis.

In another aspect, the disclosure provides a motor for a power tool. The motor includes a stator hub, an end cap, a shaft, a rotor, and a stator assembly. The stator hub includes a front plate portion positioned at a first end and a hub portion extending from the front plate portion toward a second end of the motor. The hub portion is cantilevered from the front plate portion. The end cap is positioned at the second end of the motor. The shaft extends along an axis from the end cap through the front plate portion. The shaft is supported by a front bearing and a rear bearing. The rotor is coupled to the shaft and is configured to rotate with the shaft. The stator assembly is mounted to the hub portion and positioned between the front bearing and the rear bearing along the axis. The stator hub only supports one bearing.

In another aspect, the disclosure provides a motor for a power tool. The motor includes a stator hub, an end cap, a shaft, a rotor, a stator assembly, and fan. The shaft extends from the end cap through the stator hub. The stator assembly is disposed between the shaft and the rotor is supported by the stator hub. The fan is coupled for rotation with the rotor. The rotor is coupled to the shaft by the fan. The fan is attached to the shaft between the stator assembly and the end cap to rotate the shaft in response to rotation of the rotor.

Other aspects of the invention will become apparent by consideration of the detailed description and accompanying drawings.

### BRIEF DESCRIPTION OF THE DRAWINGS

FIG. 1 is a perspective view of a prior art motor.

FIG. 2 is a cross-sectional view of the prior art motor of FIG. 1 taken along line 2-2.

FIG. 3 is a perspective view of a prior art motor.

FIG. 4 is a front view of a prior art end cap for a motor.

FIG. 5 is a perspective view of an impact tool.

FIG. 6 is a perspective view of an exemplary motor for the impact tool of FIG. 5.

FIG. 7 is a side view of the motor of FIG. 6.

FIG. 8 is a cross-sectional view of the motor of FIG. 7 taken along line 8-8.

FIG. 9 is a front view of an end cap for the motor of FIG. 6.

FIG. 10 is a table illustrating exemplary motor dimension values.

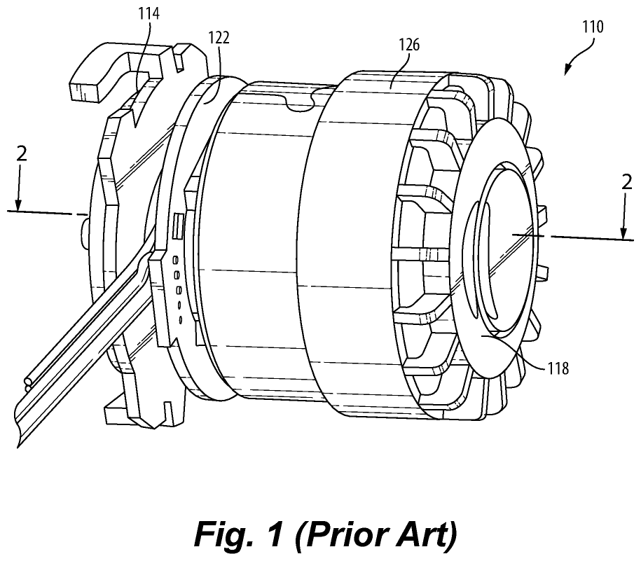

### DETAILED DESCRIPTION

Before any embodiments of the disclosed technology are explained in detail, it is to be understood that the technology is not limited in its application to the details of construction and the arrangement of components set forth in the following description or illustrated in the following drawings. The technology is capable of other embodiments and of being practiced or of being carried out in various ways. Also, it is to be understood that the phraseology and terminology used herein is for the purpose of description and should not be regarded as limiting. Any implementation described herein as “exemplary” is not necessarily to be construed as preferred or advantageous over other implementations. The detailed description uses numerical and letter designations to refer to features in the drawings. Like or similar designations in the drawings and description have been used to refer to like or similar parts of the embodiments of the technology. As used herein, the terms “first”, “second”, and “third” may be used interchangeably to distinguish one component from another and are not intended to signify location or importance of the individual components, unless otherwise context dictates otherwise. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “Iing,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further; unless expressly stated to the contrary; “or” refers to an inclusive-or and not to an exclusive-or. For example, a condition A or B is satisfied by any one of the following: A is true (present) and B is false (not present), A is false (not present) and B is true (present), and both A and B are true (present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

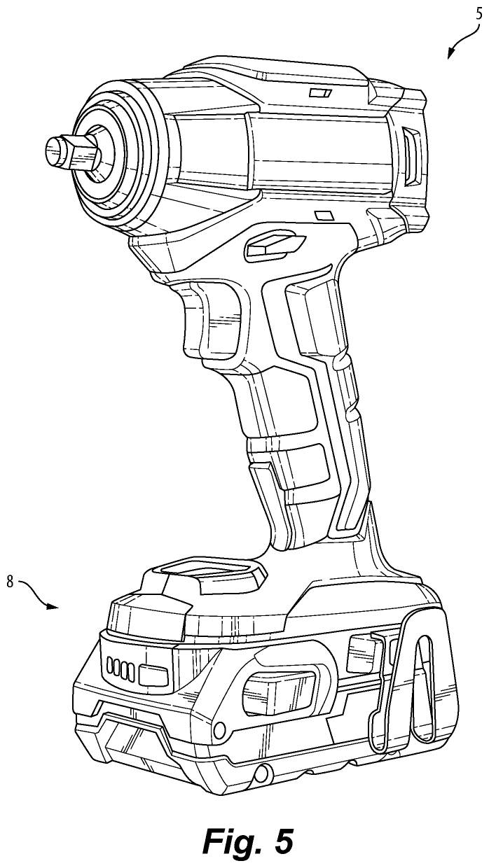

FIG. 5 illustrates an impact tool 5. The impact tool 5 is operable to supply a high torque output to selectively tighten and loosen a fastener (not shown). The impact tool 5 is battery-powered and may receive a removable and rechargeable battery 8. Additionally, the impact tool 5 is handheld to provide ease of transport and operation.

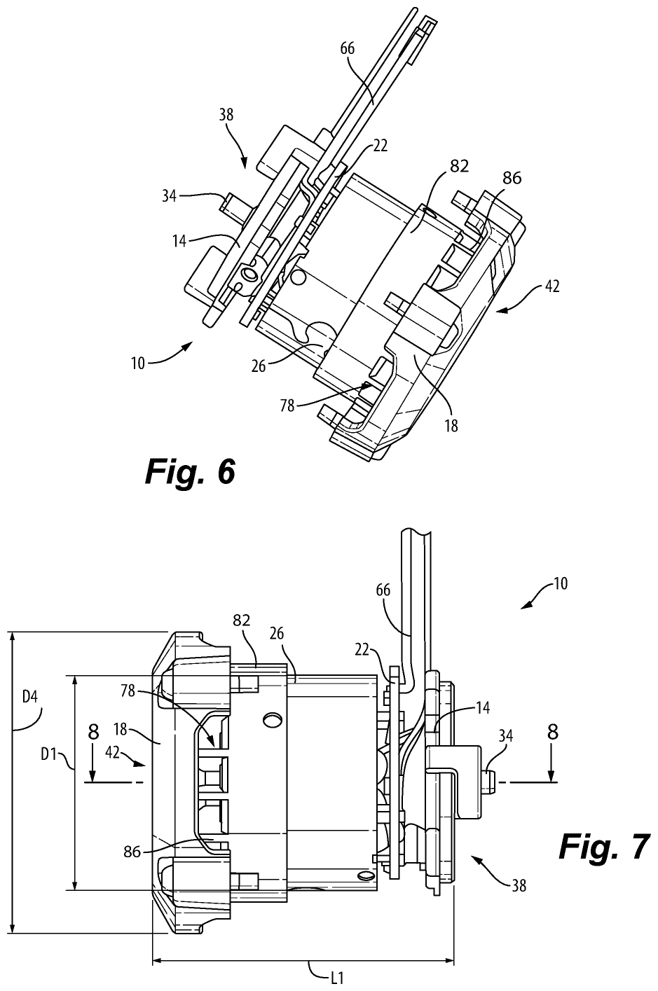

The impact tool 5 includes a motor 10. As illustrated in FIGS. 6-8, the motor 10 includes a stator hub 14, an end cap 18, a printed circuit board assembly (“PCBA”) 22, a rotor 26, a stator assembly 30, and a motor shaft 34 extending from the end cap 18 through the stator hub 14. The stator hub 14 is positioned at a front end 38 of the motor 10, and the end cap 18 is positioned at a rear end 42 of the motor 10 opposite the front end 38. The motor 10 has a first length L1 defined between the end cap 18 and the stator hub 14. That is, the first length L1 is defined between the front end 38 and the rear end 42 of the motor 10. The motor 10 additionally has a first diameter D1. In the illustrated embodiment, the first diameter D1 is defined by the outer dimension of the rotor 26. The rotor 26 and the stator assembly 30 are positioned between the end cap 18 and the stator hub 14. The rotor 26 interacts with the stator assembly 30 to drive rotation of the motor shaft 34. Rotation of the motor shaft 34 effectively drives the high torque output of the impact tool 5 of FIG. 5.

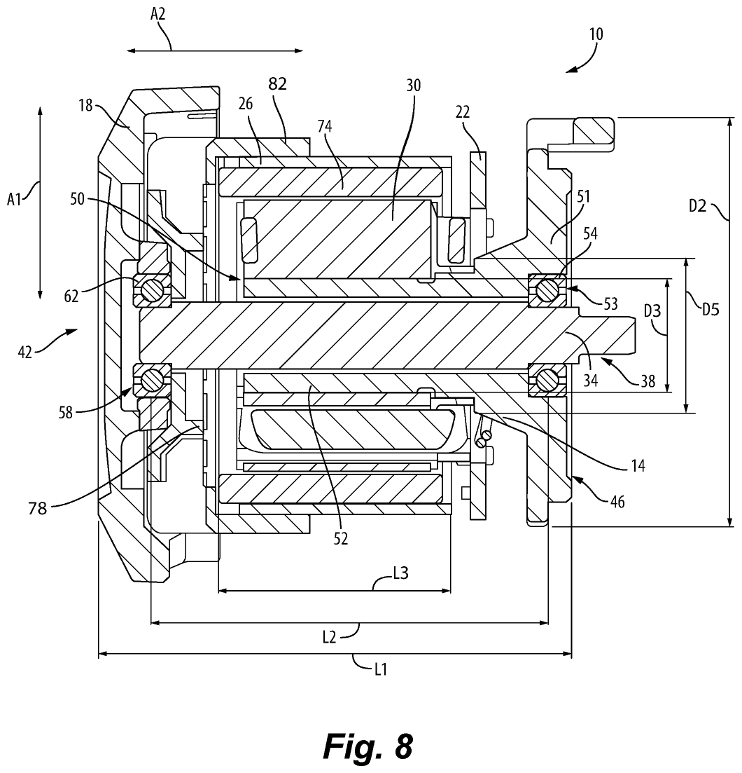

As shown in FIG. 8, the motor 10 has a “sandwich” topology. In this topology, the stator assembly 30 is inserted between the shaft 34 and the rotor 26 (i.e. two rotating components). The shaft 34 and the rotor 26 are connected adjacent a rear end of the shaft 34 and rotate at the same rotational speed and direction relative to the stator assembly 30. The stator assembly 30 is positioned between the rotor 26 and the shaft 34 along a first direction A1, which is perpendicular or transverse to a second direction or axis A2 along which the shaft 34 extends. In other embodiments, the motor 10 may have a different type of topology.

As best illustrated in FIG. 8, the stator hub 14 includes a first end 46 that faces and receives a gear assembly (not shown) of the impact tool 5 of FIG. 5, and a second end 50 opposite the first end 46. The second end 50 is positioned adjacent an end of the stator assembly 30. The stator hub 14 further includes a front plate portion 51 and a hub portion 52. The front plate portion 51 is positioned at the first end 46, and the hub portion 52 is positioned at the central portion of the motor 10 and extends to the second end 50. The front plate portion 51 has a second diameter D2, and the hub portion 52 has a third diameter D3. The second diameter D2 of the front plate portion 51 is generally larger than the third diameter D3 of the hub portion 52 for compatibility with the gear assembly.

The end cap 18 surrounds the rear of the rotor 26 and the stator assembly 30 opposite the first end 46 of the stator hub 14. The end cap 18 has a fourth diameter D4. The fourth diameter D4 is larger than the first diameter D1 such that the end cap 18 extends radially outward of the rotor 26. As such, the construction of the motor 10 enables the rotor 26 to be at least partially nested within the end cap 18. The fourth diameter D4 is larger than the second diameter D2 and the third diameter D3. In some embodiments, the end cap 18 may be formed of an aluminum material. Specifically, the end cap 18 may be formed of aluminum through a process such as, but not limited to, die-casting. Aluminum is a relatively strong conductor, and therefore, may be cooled more easily than other materials to advantageously improve thermal cooling of the motor 10. In other embodiments, the end cap 18 may be formed of a plastic material. Specifically, the end cap 18 may be formed of plastic through a process such as, but not limited to, molding. Plastic is a relatively cheap material, and molding is a relatively low-cost process such that plastic molding advantageously reduces manufacturing costs of the motor 10.

The stator hub 14 has a front bearing cavity 53 that supports a front bearing 54 at the first end 46, and the end cap 18 includes a rear bearing cavity 58 that supports a rear bearing 62. The front bearing 54 and the rear bearing 62 rotatably support the motor shaft 34 and align the motor 10 on opposite ends of the motor 10. In the illustrated embodiment, the front bearing 54 is formed of a first set of bearings, and the rear bearing 62 is formed of a second set of bearings. That is, the bearings 54, 62 are formed of sets of ball bearings in which the ball bearings of each set are uniformly spaced around the motor shaft 34. Other types of bearings, such as, but not limited to, roller bearings, may be contemplated in place of ball bearings. For the sake of brevity, the sets of bearings are referred to as the front bearing 54 and the rear bearing 62. The rear bearing cavity 58 is integrally formed with the end cap 18 and is separate from the stator hub 14 such that the end cap 18 independently retains the rear bearing 62. In some embodiments, the rear bearing cavity 58 is integrally die-casted with the aluminum end cap 18. In other embodiments in which the end cap 18 is formed of plastic, the rear bearing cavity 58 may be integrally molded with the plastic end cap 18. The front bearing 54 and the rear bearing 62 form a two-bearing support structure for the motor 10. The front bearing 54 and the rear bearing 62 are separated by a second length L2. The second length L2 extends from the center of the front bearing 54 to the center of the rear bearing 62. In the illustrated embodiment, the second length L2 is shorter than the motor length L1.

As shown in FIGS. 7 and 8, the PCBA 22 is positioned between the front plate portion 51 of the stator hub 14 and the stator assembly 30 such that the stator hub 14 extends through the PCBA 22. More specifically, the PCBA 22 is coupled to the stator hub 14. In some embodiments, the PCBA 22 may be connected to the stator hub 14 by a plurality of connectors (not shown). In such embodiments, the plurality of interconnectors ensures the PCBA 22 does not detach from the stator hub 14 even under strong vibration and shock operating conditions of the motor 10. In other embodiments, a fifth diameter D5 of the stator hub 14 at the location of the PCBA 22 may be substantially equivalent to a diameter of a central aperture of the PCBA 22 such that the PCBA 22 is secured directly to the stator hub 14 at the central aperture. In some embodiments, the PCBA 22 may be coupled to an extension protruding from the stator assembly 30. A wiring cable 66 is electronically coupled to the PCBA 22. The wiring cable 66 may extend from the PCBA 22 to the battery 8 of FIG. 5 to selectively provide power to the PCBA 22. The PCBA 22 controls operation of the motor 10.

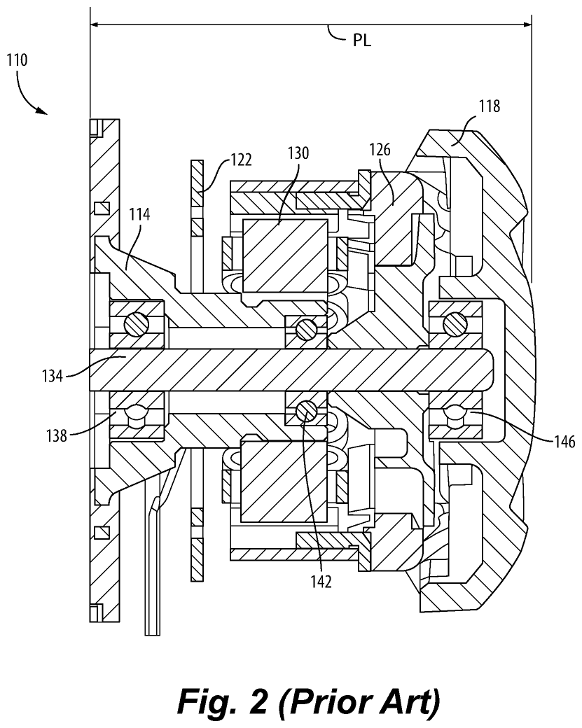

The rotor 26 and the stator assembly 30 cooperatively define a cylindrical boundary extending between the stator hub 14 and the end cap 18. In the illustrated embodiment, the cylindrical boundary defined by the rotor 26 and the stator assembly 30 has a third length L3. Specifically, the third length L3 is defined between a rear end of the rotor 26 and a front end of the stator assembly 30. The construction of the motor 10 enables the stator assembly 30 to be at least partially nested within the rotor 26 to reduce the third length L3, and as a result, reduce the first length L1 relative to a prior art motor length PL of existing motors 110 (e.g., the motor shown in FIG. 2). The rotor 26 is operably coupled to the motor shaft 34 between the stator assembly 30 and the rear bearing 62. The rotor 26 includes permanent magnets 74 that are positioned between an outer shell of the rotor 26 and the stator assembly 30. The stator assembly 30 includes a stator core that is attached to the stator hub 14 and conductive windings (not shown) that generate a magnetic field to drive rotation of the rotor 26. More specifically, the magnetic field induces movement of the permanent magnets 74 around the circumference of the stator assembly 30 to rotate the rotor 26. Rotation of the rotor 26, in turn, rotates the motor shaft 34. For example, and with reference to FIGS. 7 and 8, the motor 10 includes a fan 78 that has a shroud portion 82 and a blade portion 86. The shroud portion 82 extends over and couples to the outer shell or housing of the rotor 26. The shroud portion 82 may be coupled to the rotor 26 with fasteners, by press fit, or in other ways. The blade portion 86 extends from the shroud portion 82. The fan 78 is directly coupled to the shaft 34 such that the rotor 26 is indirectly coupled to the shaft 34 by the fan 78. That is, rotation of the rotor 26 causes rotation of the fan 78, which in turn rotates the shaft 34. In other embodiments, the rotor 26 may be directly coupled to the shaft 34. In the illustrated embodiment, the fan 78 is at least partially nested in the end cap 18, and the rotor 26 is at least partially nested in the fan 78.

With continued reference to FIGS. 7 and 8, the stator assembly 30 is positioned between the front plate portion 51 and the end cap 18 along the second direction A2. The illustrated stator assembly 30 is supported by the stator hub 14. More specifically, the stator assembly 30 is mounted to the hub portion 52 of the stator hub 14, which in turn, is cantilevered from the front plate portion 51. That is, the hub portion 52 is supported by the front plate portion 51 at the first end 46 (which may be coupled to a housing of the power tool of FIG. 5) and is free (i.e., not supported) at the second end 50. As such, the front bearing 54 provides cantilevered support for the stator assembly 30 because the front bearing 54 is only supported by the cantilevered stator hub 14. Due to the cantilever functionality of the front bearing 54, the stator hub 14 and the stator assembly 30 must be able to resist deformation and positional fluctuations in response to applied forces, particularly in the first direction A1. Therefore, the stator hub 14 and the stator assembly 30 are optimized to reduce the weight and improve the strength of each of the stator hub 14 and the stator assembly 30. Optimization of the stator hub 14 and the stator assembly 30 ensures stable operation of the motor 10 and reduces the bending moment and the shear stress acting on the motor 10. As such, the two-bearing support structure in the illustrated embodiment is generally suitable for small size motors.

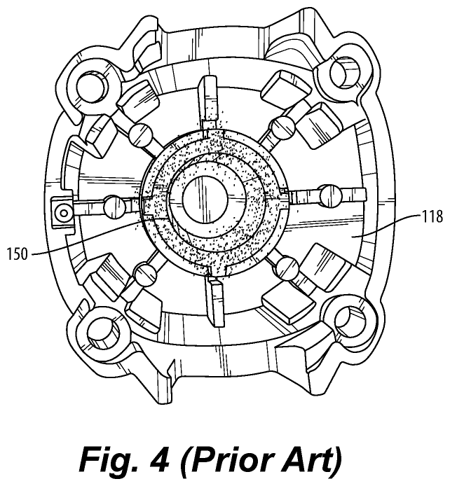

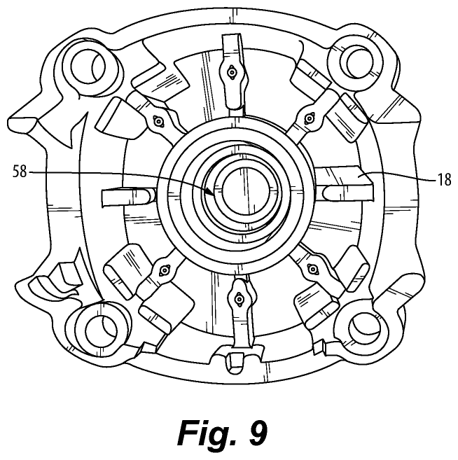

FIG. 9 illustrates that the rear bearing cavity 58 is integrally formed with the end cap 18, rather than formed by a separate bearing boot (e.g., bearing boot 150 in FIG. 4). The rear bearing cavity 58 is formed to provide direct and stiff support for the motor shaft 34 of FIG. 8. In other words, the rear bearing cavity 58 provides rigid support for the motor shaft 34, rather than a soft support, such that wobble is reduced, and in some cases, eliminated, compared to the prior art end cap 118 (FIG. 4). Additionally, the gap between the rotor 26 and the stator assembly 30, as illustrated in FIG. 8, and the overall concentricity of the motor 10 depends on placement of the end cap 18 due to the rigid support provided by the rear bearing cavity 58. Although not shown, the rear bearing cavity 58 may include a metallic ring molded to the end cap 18 to reduce vibration and noise emissions of the motor 10 while still providing rigid support for the motor shaft 34. Specifically, another embodiment of the end cap 18, although not shown, includes molding the plastic material of the end cap 18 to a metallic ring such that the rear bearing cavity 58 is defined by the internal diameter of the metallic ring. With a light press fit between the rear bearing 62 and the rear bearing cavity 58, the rigidity and concentricity of the motor 10 is maintained, and the service lifetime of the motor 10 is increased.

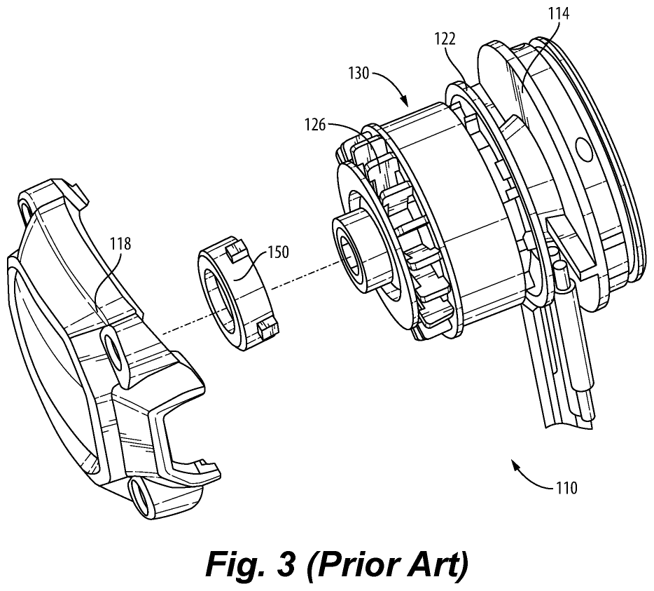

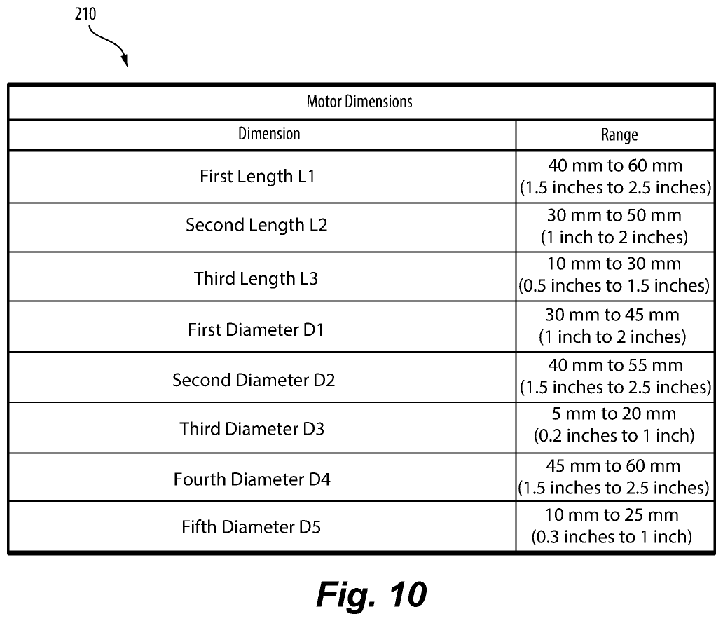

FIG. 10 illustrates a table 210 of dimensions associated with the motor 10. The table 210 includes size ranges for the first length L1, the second length L2, and the third length L3. The motor 10 construction, as described above, advantageously enables a size reduction in the lengths L1-L3 of the motor 10 compared to existing motors 110. For example, the motor 10 does not have the bearing boot 150 that is required in existing motors 110 (see FIG. 3) for mitigating over-constraint issues. As such, the rotor 26 may be recessed, or nested, further into the end cap 18 so that the motor 10 has a relatively shorter length L1 than existing motors. The first length L1 may be between 40 mm and 60 mm (1.5 inches and 2.5 inches). In the illustrated embodiment, the first length L1 is approximately 50 mm (e.g., 50.25 mm; 1.98 inches). The second length L2 may be between 30 mm and 50 mm (1 and 2 inches). In the illustrated embodiment, the second length L2 is approximately 42 mm (e.g., 42.10 mm; 1.66 inches). The third length L3 may be between 10 mm and 30 mm (0.5 inches and 1.5 inches). In the illustrated embodiment, the third length L3 is approximately 23 mm (e.g., 22.65 mm; 0.89 inches).

As illustrated in FIG. 10, the table 210 includes size ranges for the first diameter D1, the second diameter D2, the third diameter D3, the fourth diameter D4, and the fifth diameter D5. The motor 10 construction, as described above, advantageously enables a size reduction in the diameters D1-D5 of the motor 10. For example, in the absence of a third bearing (e.g., the middle bearing 142 of prior art motors 110; FIG. 2), the first diameter D1 may be reduced in size compared to prior art motors 110. The first diameter D1 may be between 30 mm and 45 mm (1 inch and 2 inches). In the illustrated embodiment, the first diameter D1 is approximately 38 mm (1.50 inches). The second diameter D2 may be between 40 mm and 55 mm (1.5 inches and 2.5 inches). In the illustrated embodiment, the second diameter is approximately 46 mm (e.g., 46.20 mm; 1.82 inches). The third diameter D3 may be between 5 mm and 20 mm (0.2 inches and 1 inch). In the illustrated embodiment, the third diameter D3 is approximately 12 mm (0.47 inches). The fourth diameter D4 may be between 45 mm and 60 mm (1.5 inches and 2.5 inches). In the illustrated embodiment, the fourth diameter D4 is approximately 52 mm (e.g., approximately 2 inches). The fifth diameter D5 may be between 10 mm and 25 mm (0.3 inches and 1 inch). In the illustrated embodiment, the fifth diameter D5 is approximately 16 mm (e.g., 16.23 mm; 0.64 inches). All dimensions contained herein are provided for example purposes only, as larger and smaller motors and motor components are contemplated.

By reducing the lengths L1-L3 and the diameters D1-D5, as described above, the motor 10 may be lighter and more compact than prior art motors 110, which leads to a lighter impact tool 5. For example, a ratio of the first length L1 (the motor length) to the first diameter D1 (the rotor diameter) is smaller than a ratio of the motor length and rotor diameter of the prior art motor 110 that has three bearings 138, 142, 146. That is, existing motors (e.g., the motor 110) with a three-bearing construction will be larger than the motor 10 due to the size constraints and additional parts (e.g., the bearing boot 150) that are necessary to support three bearings.

In operation, a user may turn on the impact tool 5 to supply power to the PCBA 22 from the battery 8. Additionally, the user may operate an actuating means (e.g., a trigger) or a user interface (not shown) to send a user input to the PCBA 22 to set a direction and a speed of rotation for the motor shaft 34. Specifically, the PCBA 22 controls the interaction between the rotor 26 and the magnetic field created by the stator assembly 30 to control the direction and the speed of rotation of the motor shaft 34. The front bearing 54 and the rear bearing 62 provide support for the motor shaft 34 and minimize rotational friction losses during rotation of the motor shaft 34. The two-bearing support structure eliminates over-constraint issues caused by misalignment consistently occurring in motor 10 structures that have more than two bearings. With over-constraint issues eliminated, the rear bearing cavity 58 may be integrally formed in the end cap 18 rather than requiring an additional component such as the bearing boot 150 of FIG. 3 for absorbing vibrational energy caused by the over constraint issues. The total part count of the motor 10 is thus effectively reduced. As such, the structure of the motor 10 is effectively simplified. Additionally, the reduced total part count and the recessed rotor 26 may cooperatively reduce the overall length of the motor 10. This motor 10 design enables the motor shaft 34 to operate at improved rotation speeds while reducing the wobble common in prior art motors 110 as shown in FIG. 2.

In some embodiments, one of the front bearing 54 and the rear bearing 62 may be moved to a different position along the motor 10. More specifically, one of the front bearing 54 and the rear bearing 62 may be moved to a position on the motor shaft 34 within the cylindrical boundary that is defined between the stator hub 14 and the end cap 18. As such, the motor 10 may have a different two-bearing support structure relative to the bearing support structure illustrated in FIGS. 5-8.

Although the invention has been described in detail with reference to certain preferred embodiments, variations and modifications exist within the scope and spirit of one or more independent aspects of the invention as described.

1. A motor for a power tool, the motor comprising:
a stator hub including a front plate portion positioned at a first end of the motor;
an end cap positioned at a second end of the motor;
a shaft extending along an axis from the end cap through the front plate portion, the shaft supported by at most two bearings spaced apart from each other along the axis;
a rotor coupled to the shaft and configured to rotate the shaft; and
a stator assembly disposed between the rotor and the shaft,
wherein each of the rotor and the stator assembly is positioned between the front plate portion and the end cap along the axis.

2. The motor of claim 1, wherein the at most two bearings includes a first bearing and a second bearing, and wherein the stator hub supports only the first bearing or the second bearing.

3. The motor of claim 2, wherein the shaft is coupled to the rotor between the rear bearing and the stator assembly.

4. The motor of claim 1, wherein the at most two bearings include a first bearing and a second bearing, wherein the first bearing is disposed in a first cavity defined by the end cap, and wherein the second bearing is disposed in a second cavity defined by the stator hub.

5. The motor of claim 1, wherein the stator hub further includes a hub portion extending from the front plate portion toward the second end of the motor such that the hub portion is cantilevered from the front plate portion, and wherein the stator assembly is mounted to the hub portion.

6. The motor of claim 5, wherein the shaft extends through the hub portion such that the hub portion is positioned between the shaft and the stator assembly.

7. The motor of claim 1, wherein the rotor is indirectly coupled to the shaft.

8. A motor for a power tool, the motor comprising:
a stator hub including a front plate portion positioned at a first end of the motor and a hub portion extending from the front plate portion toward a second end of the motor, and the hub portion cantilevered from the front plate portion;
an end cap positioned at the second end of the motor;
a shaft extending along an axis from the end cap through the front plate portion, the shaft supported by a front bearing and a rear bearing;
a rotor coupled to the shaft and configured to rotate the shaft; and
a stator assembly mounted to the hub portion and positioned between the front bearing and the rear bearing along the axis, and
wherein the stator hub supports only one bearing.

9. The motor of claim 8, wherein the front plate portion includes a front bearing cavity in which the front bearing is disposed, and wherein the end cap includes a rear bearing cavity in which the rear bearing is disposed.

10. The motor of claim 9, wherein the rear bearing cavity is integrally formed with the end cap such that the end cap directly receives and secures the rear bearing.

11. The motor of claim 8, wherein the stator assembly is positioned between the rotor and the shaft.

12. The motor of claim 8, wherein the rotor is coupled to the shaft between the rear bearing and the stator assembly.

13. The motor of claim 12, wherein the rotor is indirectly coupled to the shaft.

14. The motor of claim 8, wherein the rotor includes a fan positioned axially between the stator assembly and the end cap, and wherein at least a portion of the fan is positioned axially between the rear bearing and the end cap.

15. A motor for a power tool, the motor comprising:
a stator hub;
an end cap;
a shaft extending from the end cap through the stator hub;
a rotor;
a stator assembly disposed between the shaft and the rotor and supported by the stator hub; and
a fan coupled for rotation with the rotor;
wherein the rotor is coupled to the shaft by the fan, and
wherein the fan is attached to the shaft between the stator assembly and the end cap to rotate the shaft in response to rotation of the rotor.

16. The motor of claim 15, further comprising a first bearing supported by the end cap and a second bearing supported by the stator hub.

17. The motor of claim 15, wherein the stator hub supports only one bearing.

18. The motor of claim 15, wherein the shaft is rotatably supported by at most two bearings spaced apart from each other along the axis.

19. The motor of claim 15, wherein the stator hub includes a front plate portion and a hub portion extending and cantilevered from the front plate portion, and wherein the stator assembly is mounted to the hub portion.

20. The motor of claim 15, wherein the fan is at least partially nested within the end cap, and wherein the rotor is at least partially nested in the fan.
